(19) United States
(12) Patent Application Publication
(10) Pub. No.: US 2008/0028323 A1
(43) Pub. Date: Jan. 31, 2008

(54) Method for Initiating and Launching Collaboration Sessions

(76) Inventors: Joshua Rosen, Bolinas, CA (US); Stuart Feldman, Montreal (CA); Juan Pablo Di Lelle, Montreal (CA)

Correspondence Address: PATTERSON & SHERIDAN, L.L.P., 3040 POST OAK BOULEVARD, SUITE 1500, HOUSTON, TX, 77056, US

(21) Appl. No.: 11/829,564

(22) Filed: Jul. 27, 2007

Related U.S. Application Data
(60) Provisional application No. 60/820,543, filed on Jul. 27, 2006.

(51) Int. Cl. G06F 3/00

(52) U.S. Cl. 715/752

(57) ABSTRACT

A document collaboration process is centered around a digital media object that is the subject of the collaboration, and makes the role of the server computer that is hosting the collaboration session more transparent to the user. As a result, a user can initiate a collaboration session without logging into the server computer and uploading the digital media object into the server computer. A user can also join a collaboration session without logging into the server computer. The process for initiating a collaboration session may be performed directly from the browser while viewing a web page, directly from an e-mail interface while viewing an e-mail, directly from an Instant Messaging Interface while participating in an IM session or directly from a file browser while viewing a list of files stored in the user computer.

### CROSS-REFERENCE TO RELATED APPLICATIONS

This application claims the benefit of U.S. provisional patent application Ser. No. 60/820,543, filed Jul. 27, 2006, which is herein incorporated by reference.

### BACKGROUND OF THE INVENTION

1. Field of the Invention

The present invention relates generally to collaboration systems and, more particularly, to a collaboration system that permits users to seamlessly initiate collaboration sessions and launch collaboration sessions from an e-mail or Instant Messaging interface.

2. Description of the Related Art

The early Internet was dominated by static web pages that were updated rarely, if at all. As Internet usage increased, dynamic web pages became more common. Content management systems served dynamic pages that were generated on-the-fly from content databases that were constantly updated. For the most part, the content made available on these web sites were created and organized by the web sites themselves or syndicated from other web sites.

Many web sites today rely on users to create and organize the content that are made available on their web sites. In general, these web sites provide a software platform that encourages user participation through creation, organization and sharing of content. Rather than focusing on the creation of the content that is available on their web sites, their focus has been on providing the facilities and framework for users to publish their own content.

The attractiveness of these web sites is their potential ability to grow the user base exponentially through viral marketing and to leverage the entire user base to supply and organize relevant content. The objective is to have much of the marketing of the web site and the creation and organization of the content on the web site be carried out by the users themselves, so that the cost of operating such a web site can be kept very low.

Some of the more popular technologies that have been developed to enable the creation, organization and sharing at these web sites include blogging, podcasting, RSS feeds, wikis, and tags. Blogging provides users with a platform and tools to compose content for sharing with other users. Podcasting provides users with a platform and tools to select and organize multimedia content to be shared with other users. RSS feeds are used by these web sites to receive summaries of web content together with links to the full versions of the content from other web sites. Wikis provide a common platform for a group of users to collaborate in generating content. Tags are user-defined keywords for classifying content and are used to organize content created and published by users.

Web based conferencing solutions also permit users to collaborate over the Internet. In such an environment, attendees can view documents and images that are being presented by a conference leader and communicate with one another verbally over the Internet or by a separate telephone connection. Some solutions like Microsoft Office Live Meeting permit the conference leader to run desktop applications on his or her computer and permit the attendees to view the graphical user interface (GUI) of the desktop applications so that they can view the inputs made through the GUI as well as outputs generated in response thereto.

The web based conferencing solutions described above has a limitation in that one person, i.e., the conference leader, has control over the documents and images being presented and the desktop application. The attendees are merely passive observers who consume information that is supplied to them. Any collaboration by the attendees is by verbal communication.

U.S. Patent Application Pub. No. 2006/0026502 discloses a document collaboration system that permits participants to collaborate more actively. This system permits multiple participants to view, markup, and annotate a document simultaneously and in real-time using a web browser. To participate in a document collaboration session, the user logs into a web site that hosts this document collaboration system at the time designated by the initiator. The initiator sends notification of the document collaboration session to the participants by e-mail.

One disadvantage in the document collaboration process disclosed in U.S. Patent Application Pub. No. 2006/0026502 is that a considerable amount of effort is expended in setting up the document collaboration session. First, a document to be collaborated on has to be uploaded into the collaboration server. Second, an invitation has to be sent out to the participants. Third, the participants need to be registered with the web site that is hosting the document collaboration session and are required to log in at the designated time to begin the collaboration session.

### SUMMARY OF THE INVENTION

The present invention provides a more efficient collaboration process. The collaboration process according to embodiments of the present invention is centered around an object (e.g., digital media such as an image, a video, a document, a CAD drawing, a 3D model) that is the subject of the collaboration, and makes the role of the server computer that is hosting the collaboration session more transparent to the user. As a result, with the present invention, a user can initiate a collaboration session without logging into the server computer and uploading the object onto the server computer. A user can also join a collaboration session without logging into the server computer.

According to one embodiment of the present invention, a collaboration session may be initiated by a user while viewing a web page using a browser by selecting an object on that web page, activating a contextual menu and selecting the option to initiate a collaboration session from the contextual menu. The user then inputs his or her e-mail address, e-mail addresses of those invited to join the collaboration session, and any comments. In response to the submission of these inputs, an e-mail communication is generated and transmitted to the invitees. The e-mail communication includes a representation of the object (e.g. a thumbnail image) and a hyperlink that permits the e-mail recipient to join the collaboration session by clicking on the hyperlink.

According to another embodiment of the present invention, a collaboration session may be initiated by a user directly from a desktop of the user's computer by selecting a file name corresponding to an object to activate a contextual menu and selecting the option to initiate a collaboration session from the contextual menu. The user then inputs his or her e-mail address, e-mail addresses of those invited to join the collaboration session, and any comments. In response to the submission of these inputs, an e-mail communication is generated and transmitted to the invitees. The e-mail communication includes the thumbnail representation of the object and a hyperlink that permits the e-mail recipient to join the collaboration session by clicking on the hyperlink.

Because of the asynchronous nature of e-mail communications, the present invention is particularly applicable to asynchronous collaboration sessions. However, the present invention also supports synchronous collaboration sessions (e.g. if more that one invitee is collaborating on an object at the same time all the collaborators can see in real-time what the others are doing). In this embodiment, the initiator facilitates a synchronous session by specifying a time and date for the collaboration session and the e-mail communication is prepared as a calendar item to be added to the recipient's calendar. This calendar item includes the thumbnail representation of the object that is the subject of the collaboration and a hyperlink that launches the collaboration session. This calendar item may, optionally, be added automatically to the initiator's on-line or desktop calendar.

Another embodiment that is well suited to synchronous collaboration sessions is the initiation of a collaborative session on an object through an Instant Messaging (IM) application. In this embodiment, the user initiates a collaborative session by clicking on a button on the IM interface to “Send Object for Collaboration.” Other participants in the IM session receives a hyperlink for joining the collaboration session through their respective IM interfaces and can join the collaborative session by clicking on the hyperlink.

With the present invention, collaboration sessions may be initiated from the server computer as well. In this embodiment, a user logs into the server computer that is hosting the collaboration session, selects an object that is the subject of the collaboration, and generates an e-mail communication to invitees through an interface provided by the server computer. The e-mail communication includes the thumbnail representation of the object and a hyperlink that permits the e-mail recipient to join the collaboration session by clicking on the hyperlink.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 illustrates a networked computer environment in which the present invention may be practiced.

FIG. 2 is a schematic representation of a GUI generated by a collaboration server.

FIGS. 3A-3E are schematic representations GUIs that can be used to initiate collaboration sessions.

FIG. 4 is a schematic representation of an e-mail interface from which a collaboration session can be launched.

FIGS. 5A and 5B illustrate two different ways a collaboration session can be launched from an e-mail interface.

FIG. 6 is a schematic representation of a calendar entry that is generated as an invitation to join a collaboration session at a scheduled time.

FIG. 7 is a flow diagram that illustrates the steps to initiate and launch a collaboration session.

FIG. 8 is a flow diagram that illustrates the steps to manage a collaboration session after it has been launched.

FIG. 9 is a schematic diagram of an embodiment of the collaboration server.

FIG. 10 is a high-level physical representation of the software stack of the collaboration server.

### DETAILED DESCRIPTION

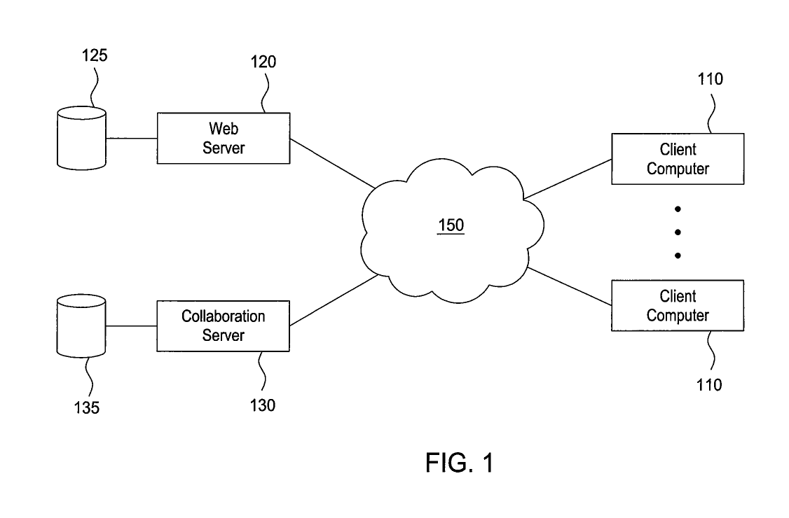

FIG. 1 illustrates a networked computer environment in which the present invention may be practiced. As shown, the networked computer environment includes a plurality of client computers 110 (only two of which are shown), web servers 120 with associated content storage units 125 (only one of which are shown), and a collaboration server 130 with an associated content storage unit 135. The client computers 110, the web server computers 120, and the collaboration server 130 are connected over a computer network 150, e.g., the Internet.

Each client computer 110 includes conventional components of a computing device, e.g., a processor, system memory, a hard disk drive, input devices such as a mouse and a keyboard, and output devices such as a monitor (not shown). Each of the web servers 120 and the collaboration server 130 includes a processor and a system memory (not shown), and manages the contents stored in its respective content storage unit using a relational database software. The web servers 120 and the collaboration server 130 are programmed to communicate with the client computers 110 and with each other using the TCP/IP protocol. The client computers 110 are programmed to execute web browser programs and access the web pages managed by the web servers 120 and the collaboration server 130 by specifying a uniform resource locator (URL) into the browser.

In the embodiments of the present invention described below, users are respectively operating the client computers 110 that are connected to the web servers 120 and the collaboration server 130 over the Internet. The web pages that are displayed to a user are transmitted from the web servers 120 and the collaboration server 130 to that user's client computer 110 and processed by the web browser program stored in that user's client computer 110 for display through the monitor of that user's client computer 110.

The collaboration server 130 is configured to host a collaboration session for objects (e.g., digital media such as an image, a video, a document, a CAD drawing, a 3D model). One embodiment of the collaboration server 130 and its associated features and functionalities is described in U.S. Patent Application Pub. No. 2006/0026502, the entire contents of which are incorporated herein by reference.

Another embodiment of the collaboration server 130 is provided by Cozimo Technologies, Inc. and is accessible using the URL: http://www.cozimo.com. The Cozimo web site provides an online collaboration tool for users who work on projects requiring the creation and review of digital media and documents. It offers users a secure and private online environment for managing the review cycles of their projects. The unique annotation tool allows the users to review and annotate digital media and documents with colleagues and clients, either together in real-time web conferences or individually, at the convenience of each project participant. As a web based application, this tool requires no specialized software application downloads. It operates on virtually all operating systems and web browsers. This means that users involved in common projects can collaborate effectively from anywhere in the world so long as an Internet connection is available.

The Cozimo web site is organized around user-defined projects and project work groups. In general, each user-defined project corresponds to some real-world project or task that the user is involved in. Each project can support a distinct file system for organizing the digital content of the project into any number of folders. Each project will also have any number of members who are invited to participate as collaborators on the project. The project owner and the invited users who accept the invitation constitute the project work group or project members. A user may be both a member in projects created and managed by other users as well as the creator and manager of the user's own projects.

Each project member may be given a specific role that defines how he or she may participate in the project. By default, a member will have the role of reviewer who has the ability to view, annotate and comment on any posted content. A member may be assigned the role of contributor. A contributor has the right to upload his or her own content to the project. A member may also be assigned the role of owner to provide full administrative privileges to the member, including the ability to manage project memberships. In addition to defining roles for each project member, a project creator may also designate a member as private. The participation of private members, and any annotations or comments they make, will not be visible to other project members except for the owners.

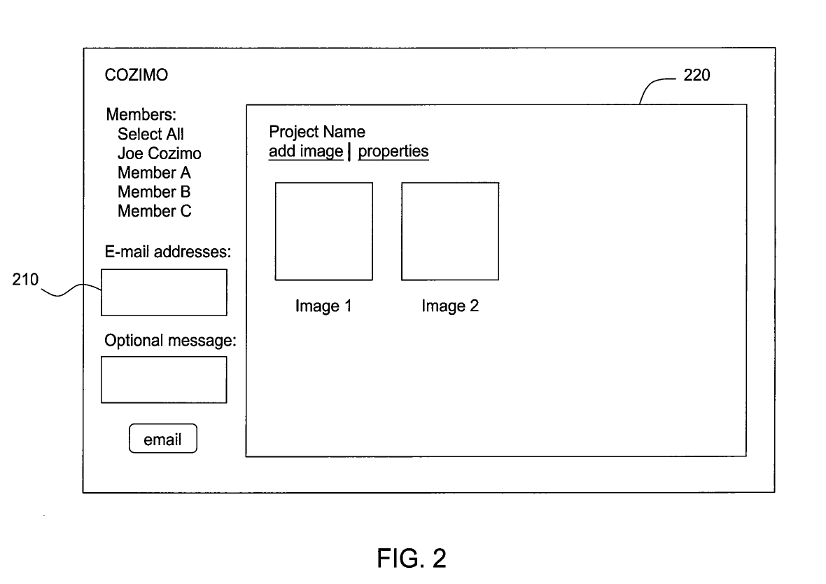

When a user accesses a project, the project contents and a list of all members of that project, with the exception of private members, are displayed to the user. A sample illustration of this is provided in FIG. 2. A click on the name of any member will cause to be displayed the contact information from that member's personal profile which has been provided by that member.

The owner of a project can define the “state” of an object that establishes who has the ability to view and collaborate on it. If the state of an object is set as “visible,” all project members can view and annotate it. If the state is set as “private,” only the owners of the project can view it and it will be hidden from all other project members. This makes it possible for the owner to set up items for review in advance and then to reveal them all at once at a specified time and/or only for a specific time period. If the state is set as “public,” the object could be viewed by anyone who is provided with a hyperlink to it. This makes it possible to share or collaborate on objects with people who are not normally part of a project workgroup.

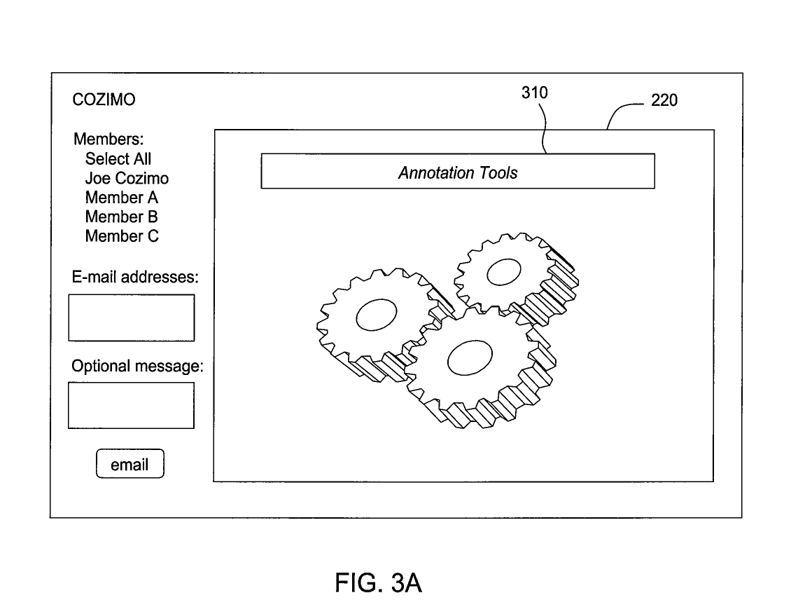

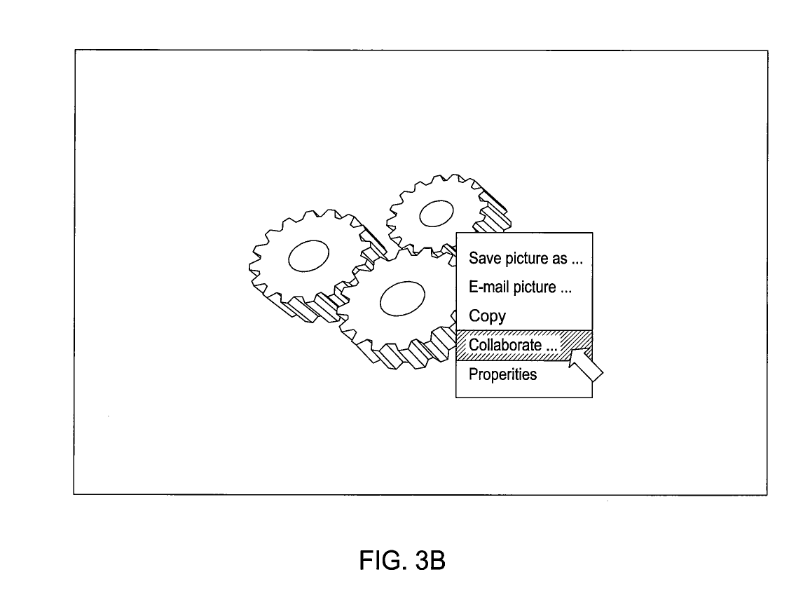

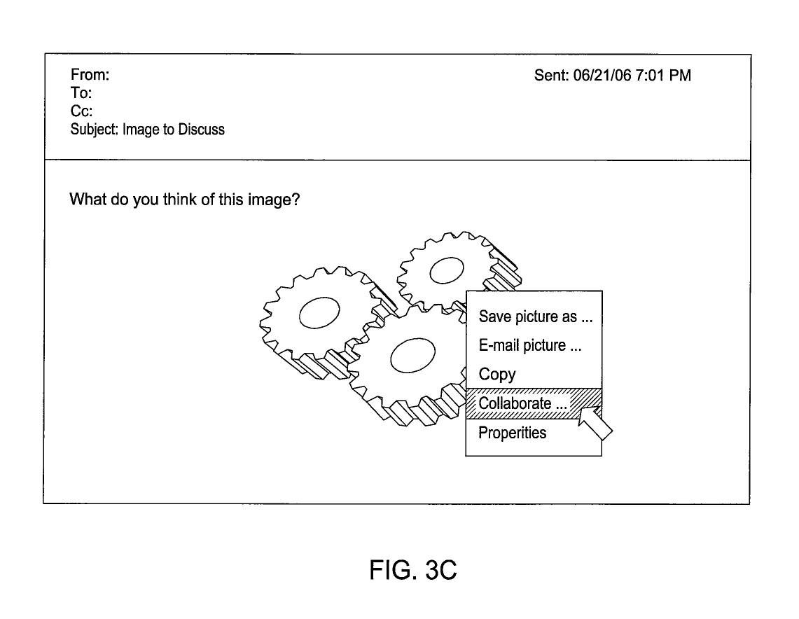

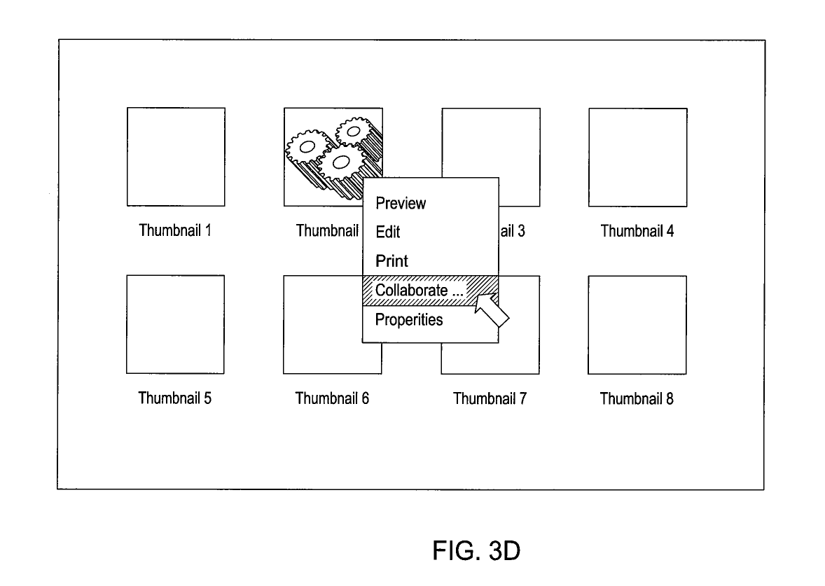

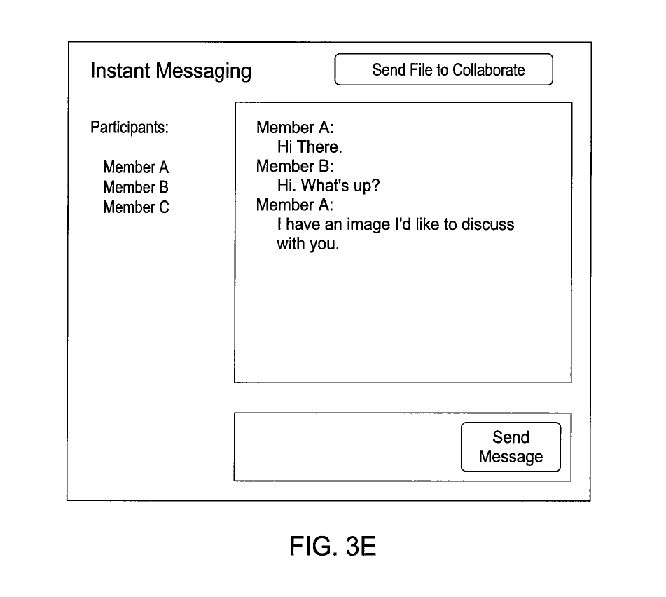

A specific object may be selected and opened for collaboration. FIG. 3A provides an illustration of the GUI that is displayed to the user when the user opens an object into the workspace 220. If the user wants to collaborate with project members on a specific object that is displayed in the workspace 220, he or she may select the desired members and click on the “email memo” button to e-mail a memo to those members that includes a hyperlink to the object that is displayed. If the object is public, then additional e-mail addresses may be entered in the input section 210 and the e-mail message is sent to those addresses as well. Any e-mail address may be entered in the input section 220, even e-mail addresses of those who are not registered users of the Cozimo web site.

Object annotation tools 310, represented schematically in FIG. 3A, are displayed when an object is opened in the workspace 220. With these tools, project members can view and mark-up objects with specific instructions and comments. The specific tools that are made available will depend upon the type of object being collaborated on. The annotations of each project member are stored on individual “layers” that can be turned on or off for visibility by that project member and other project members, with the exception that the participation and notes of private members will only be seen by project owners. Project members can make annotations individually, at their convenience (asynchronously), or they can be online simultaneously and collaborate in real-time (synchronously). Any mark-ups made by one project member will be instantly seen by all the other project members who are online. This feature greatly facilitates a teleconference where specific points or features of an object can be easily pointed out during the conversation.

The object annotation tools include the following: a pencil tool, a shape tool, a palette tool, a pan tool, a zoom tool, a crop tool, a note tool, a discussion tool, a text tool, a track tool, a navigation tool, a page tool, a video scrub tool, a control tool, an approval tool, a delete tool, an undo tool, a presentation tool, and a layer visibility tool. Each of these tools is described below. Unless indicated otherwise, each tool is activated by clicking a button on the annotation toolbar to set the functionality of the mouse:
The pencil tool sets the mouse to draw mode. The user clicks and holds down the mouse button to draw a freeform line on the object displayed.
The shape tool sets the mouse to draw a specific shape that is selected first from a pull-down menu (line, arrows, double arrows, circles and rectangles). The user clicks and drags the mouse to indicate the size and location of the shape on the object displayed.
The text tool allows the user to type text directly onto the object being displayed.

The user clicks the mouse to indicate where on the display to initiate the text and then types the text desired. The user can click and drag the text to move it to a different position or double click on the text to continue editing it.
The color, thickness and opacity of any lines drawn may be selected from the palette tool. The fonts style and size of text may also be selected from the palette tool.
The navigation tool is used to select which object is currently displayed for review and annotation. Often, a user will upload into a folder a series of objects that they wish to review with collaborators online. The navigation tool provides buttons that allow the user to move to the next or previous object in a series. The navigation tool also optionally displays a scrollable “filmstrip” of thumbnail images of all the objects in the current series. The user can double click on a desired thumbnail to immediately load the associated object for review and annotation.
The pan tool is used to adjust the region of the object that is being displayed. The object can be panned by clicking and holding down a mouse button while dragging the mouse over the displayed object. While using another tool, a temporary switch to the pan mode is possible by holding down a hotkey.
The zoom tool is used to magnify up or down the object being displayed. The object can be dynamically zoomed by clicking and holding down a mouse button while dragging the mouse over the displayed object. While using another tool, a temporary switch to the dynamic zoom mode is possible by holding down a hotkey. In addition to dynamic zooming of the object, specific magnification ratios can also be set by selecting the desired magnification from a pull-down menu. These include 50%, 100%, 200%, “fit to window.” Alternatively, the user may enter a desired magnification ratio in an input field or click and drag out a region of the displayed object so that the region selected will expand to fit the window.
The crop tool is used to highlight a particular region of a displayed object. The user clicks and drags the mouse over the object display to define a window. The inside of the window remains transparent while the outside of the window is masked by a semi-transparent screen. Once defined, location of the window may be moved by clicking and dragging on it. The size of the window may be modified by clicking and dragging on any corner of the window.
The note tool is used to leave a “post-it note” on the image. Notes can be used to maintain a discussion thread relating to a specific feature of the object being reviewed. The note is created by clicking the mouse on the desired feature. The creator of the note may then enter a comment that will then be displayed along with a time stamp showing the date and time of it's creation. Other users may then enter responses to the comment. Comments may be entered and displayed asynchronously or synchronously providing real-time instant messaging functionality. The note may be resized or moved to its optimum position. Notes can be minimized so that they do not block out the display of the object underneath. A “pin” icon will show the origin location of each note and indicate the feature of interest. If a note is minimized, double clicking on its pin icon will open it. As a note is moved around, a line is drawn between it and its pin to maintain visually the association. Notes are automatically incremented numerically so that members can easily refer to specific notes when discussing them or leaving additional comments.
The discussion tool is used to maintain a general discussion thread relating to the object being reviewed. Like the note tool, users can enter comments asynchronously or synchronously providing real-time instant messaging functionality. The discussion window can be resized or minimized.
The delete tool is clicked on to remove annotations that the user has made. As the user moves the mouse over existing annotations, they highlight to provide indication of which annotations are selected for removal. Clicking in the mouse button then deletes the annotations selected. Users can also drag a box around a number of annotations to select them for deletion. The delete tool also provides a pull-down menu for deleting all the annotations made by the user or, in the case of a project owner, all the annotations made by all users.
The Undo tool is used to retract the last operation the user performed while annotating the object. The user may click the Undo button multiple times to step back and retract any number of operations in reverse sequence from which they were performed.
The presentation tool is used to control the display of objects amongst all online participants in a collaboration session. In typical use, users individually control which object they are viewing at any given time. With the presentation tool, a single user can assume control of the object display amongst all online users. This is used, for example, when a creative director wishes to review a sequence of objects with a geographically diverse group of people. The director wants to ensure that all the people are viewing the same object at the same time. When the presentation tool is activated by one user, that user then assumes control of the pan, zoom, video scrubbing, page and navigation tools of all other users participating in the collaboration session.
The track tool is used to save all the current annotations associated to a particular object under a specific name. An object may have any number of annotation tracks associated to it. The annotation track is useful in the situation when a group of people is online annotating an object and the display becomes too full to add further annotations. The user can click on the track tool and provide a name under which all the existing annotations can be saved. The user can then clear all the existing annotations so that the collaboration session can continue. To return to a particular track at a later time (i.e., to restore the annotations that were saved), the user selects the desired track name from a pull-down menu.
The video scrub tool is used to control the playback of video clips in the annotation tool. The scrub tool controls, play, pause, fast forward, fast reverse, one frame forward, one frame reverse, and sliding scroll bar that lets the user immediately position the playback to a particular frame of the video. Using the scrub tool, users can select a single frame or range of frames and add a “bookmark” that would be represented by an icon located under the scroll bar indicating the frame(s) selected. When a bookmark is created, a new annotation track is automatically associated to it. When a user clicks on a scrub bar bookmark icon, the video playback will advance to the initial frame of that bookmark and display the annotation track associated to it.
The page tool is used to navigate through objects that have multiple pages such as documents or PowerPoint presentations. The page tool indicates how many pages exist in the object and provides buttons for advancing to the next or previous page. It also provides an input field where the user can directly enter a the page desired. Like the video scrub tool, each page of an object will automatically have a unique annotation track associated to it that will be displayed when the user advances to that page.
The visibility layer tool is a menu displaying a list of the names of all the users who have contributed annotations to an object. Associated to each name is a checkbox that a user can check to turn on or off the display of all the annotations made by the named user. Also associated to each name is an icon that indicates if the named user is currently online and viewing the same object. In a situation where the collaboration session is in presentation mode, the icon will flash to indicate to the presentation giver when a new object being loaded has finished loading on the named persons local computer.
The approval tool is used to allow a user to indicate their approval of the object being reviewed. This would be user in a situation, for example, where a creative director wants a client to approve a particular image or document for publication. The user can click on the approval tool and then check a checkbox on a menu indicating either their approval or rejection of the object. The approval status of the object will then be displayed to project owners on the “contributor list” menu associated to each object.

After a project is completed, it may be archived onto the user's local computer. The downloaded archive will provide the user with all the original content together with any associated comments and annotations that were created through the Cozimo web site. This archive will be readable on any computer and will provide a complete record of any work undertaken on the Cozimo web site.

Cozimo offers an alternate way of collaborating on objects that does not require the prior creation of project workgroups. Users may upload objects to a generic public folder (e.g., not associated to any project). A public object can then be collaborated on with anyone by e-mailing them a message that includes a hyperlink of the object. The e-mail recipient can then click on the hyperlink in the e-mail to access and annotate the object. If e-mail addresses are entered in the input section 210, the e-mail message is sent to those addresses as well. Any e-mail address may be entered in the input section 220, even e-mail addresses of those who are not registered users of the Cozimo web site.

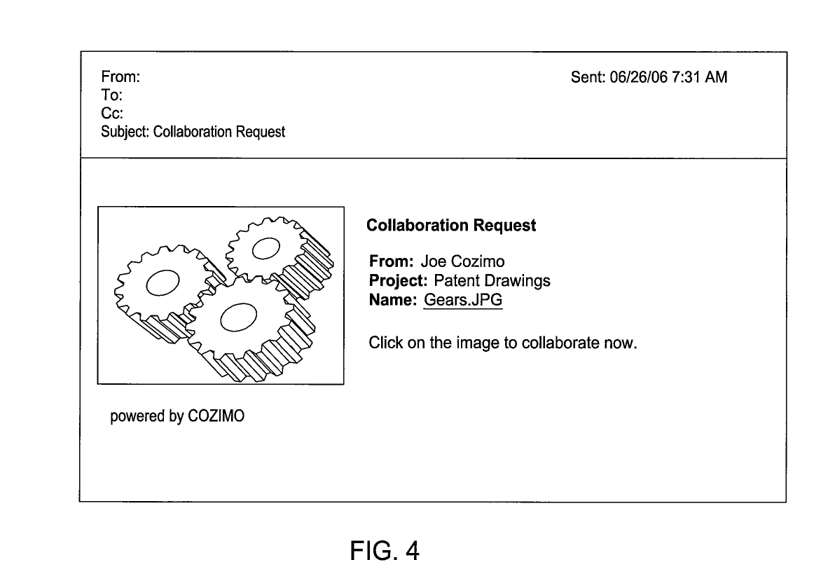

Users can initiate a collaboration session in several ways. The conventional way of initiating a collaboration session is to upload an object to be collaborated on onto the collaboration server 130 and notify the members that collaboration on the object is sought. Members then log into the collaboration server 130 over the Internet, access the object, and annotate it. The collaboration may be carried out synchronously or asynchronously. The present invention provides alternative ways to initiate a collaboration session on an object. According to a first embodiment of the present invention, a web browser is configured with an extension so that a contextual menu that is displayed (e.g., when the right mouse button is pressed while the mouse cursor is positioned over an image on a web page) additionally includes the option “Collaborate . . . .” This is illustrated in FIG. 3B. A selection of this option from the contextual menu causes a dialog to open. The dialog prompts the user to enter the user's e-mail address, one or more additional e-mail addresses, and a message. When the user confirms these inputs, these inputs along with the object are transmitted to the collaboration server 130. The collaboration server 130 stores the object, prepares an e-mail message including a thumbnail image representation of the object and an invitation to collaborate on the object, and transmits this e-mail message to the e-mail addresses entered by the user. FIG. 4 provides a schematic representation of this e-mail message.

According to a second embodiment of the present invention, an e-mail program is configured with an extension so that a contextual menu that is displayed (e.g., when the right mouse button is pressed while the mouse cursor is positioned over an object in an e-mail message) additionally includes the option “Collaborate . . . .” This is illustrated in FIG. 3C. A selection of this option from the contextual menu causes a dialog to open. The dialog prompts the user to enter the user's e-mail address, one or more additional e-mail addresses, and any message. When the user confirms these inputs, these inputs along with the object are transmitted to the collaboration server 130. The collaboration server 130 stores the object, prepares an e-mail message including the a thumbnail image representation of the object and an invitation to collaborate on the object, and transmits this e-mail message to the e-mail addresses entered by the user. FIG. 4 provides a schematic representation of this e-mail message.

According to a third embodiment of the present invention, an operating system is configured with an extension so that a contextual menu that is displayed (e.g., when the right mouse button is pressed while the mouse cursor is positioned over an object in an file folder) additionally includes the option “Collaborate . . . .” This is illustrated in FIG. 3D. A selection of this option from the contextual menu causes a dialog to open. The dialog prompts the user to enter the user's e-mail address, one or more additional e-mail addresses, and any message. When the user confirms these inputs, these inputs along with the object are transmitted to the collaboration server 130. The collaboration server 130 stores the object, prepares an e-mail message including the a thumbnail image representation of the object and an invitation to collaborate on the object, and transmits this e-mail message to the e-mail addresses entered by the user. FIG. 4 provides a schematic representation of this e-mail message.

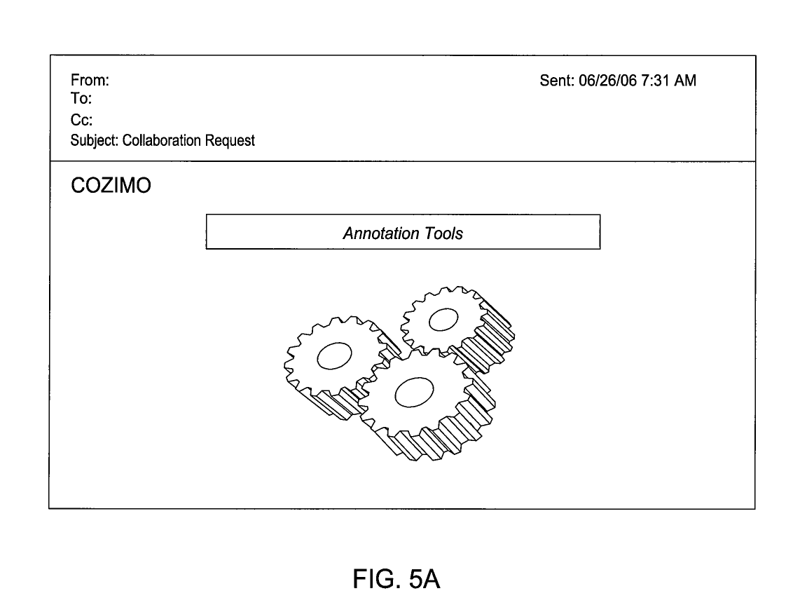

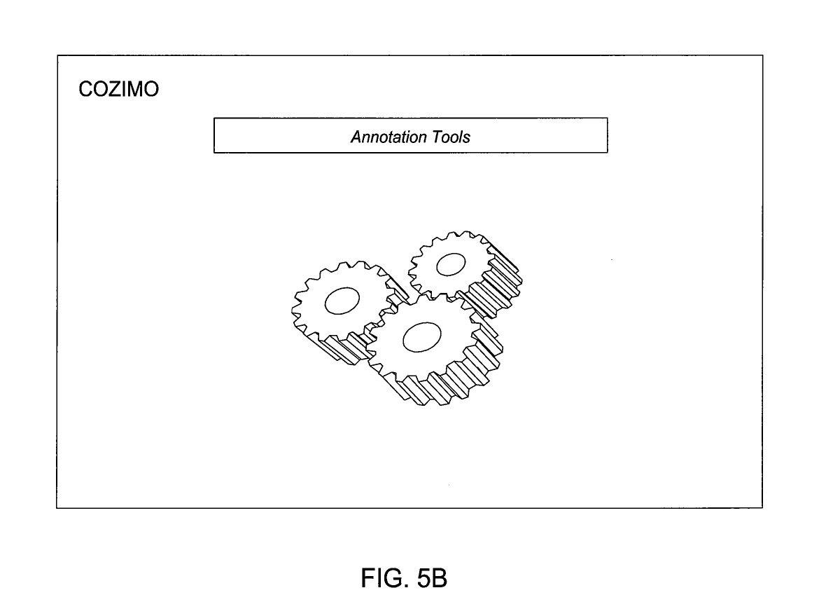

The content of the e-mail message shown in FIG. 4 includes the thumbnail image representation of the object and a hyperlink to launch the collaboration session to which the e-mail recipient was invited. In certain e-mail interfaces, a click on this hyperlink causes the collaboration session to be launched within the e-mail program environment. This example is illustrated in FIG. 5A. In other e-mail interfaces, a click on this hyperlink causes a new web browser window to open up and the collaboration session to be launched within the new web browser window. This is illustrated in FIG. 5B.

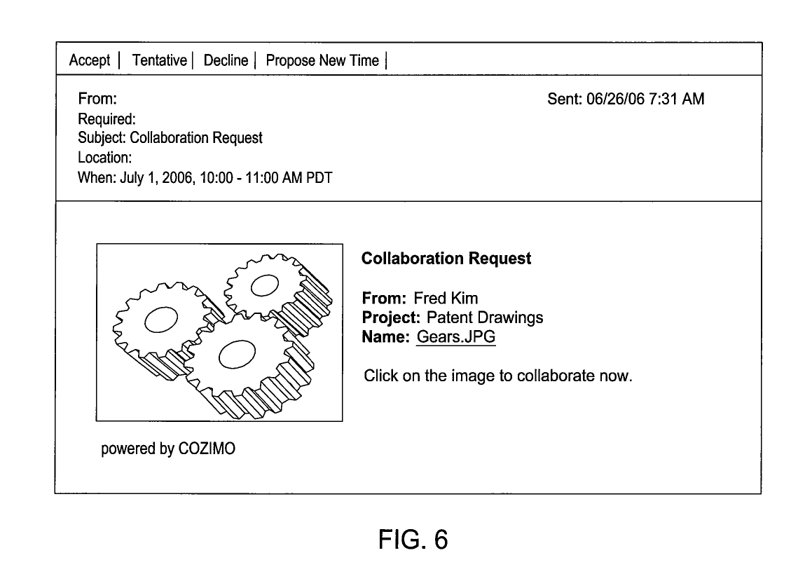

According to another embodiment of the present invention, the dialog that opens up in response to a selection of the “Collaborate . . . .” item from the contextual menu may prompt the user for inputs as to the time and date of the collaboration session. If these inputs are entered, the e-mail message that is prepared by the collaboration server 130 is generated and transmitted as a calendar item that can be added directly to the calendar of the e-mail recipient. This calendar item includes the thumbnail image representation of the object that is the subject of the collaboration and a hyperlink that launches the collaboration session, and is illustrated schematically in FIG. 6. Upon submission of the time and date inputs, this calendar item is also added automatically to the initiator's calendar.

According to a fourth embodiment of the present invention, an Instant Messaging software application is configured with an extension so that a button is displayed that offers the ability to “Send Object for Collaboration.” This is illustrated in FIG. 3E. Clicking on this button causes a dialog to open. The dialog prompts the user to “Browse” their local computer file system and enter the name of an object file from their local computer or, alternatively, a hyperlink to an object stored on another computer. When the user provides these inputs, the object is transmitted to the collaboration server 130 (this may be the same server managing the IM session). The collaboration server 130 stores the object and transmits a hyperlink to it to all the users participating in the Instant Messaging session. The users participating in the Instant Messaging session receive this hyperlink with an invitation to collaborate on this object, and those who click on this hyperlink launch a collaborative session on the object.

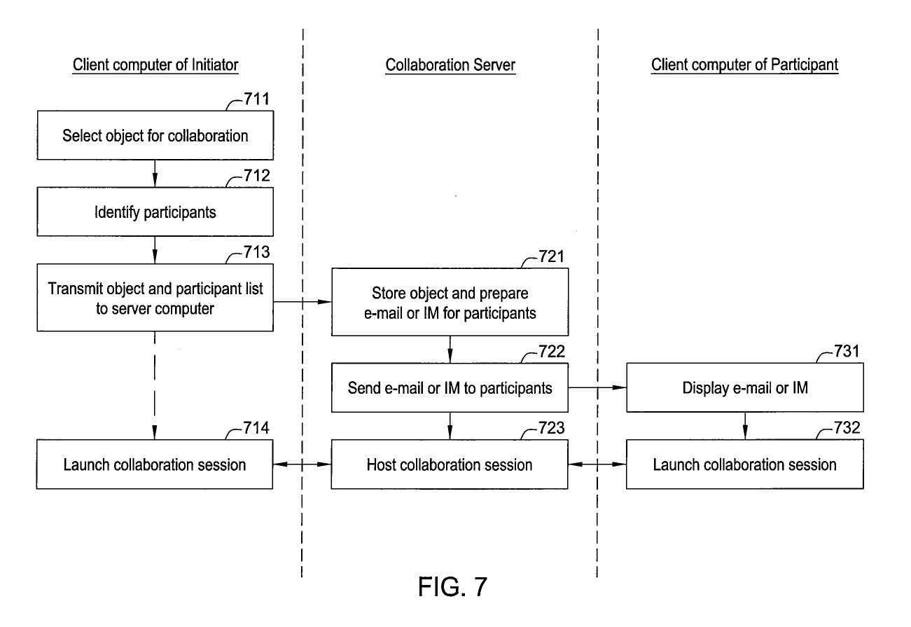

FIG. 7 is a flow diagram that illustrates the steps to initiate and launch a collaboration session. Steps 711-714 represent those steps that are carried out at the client computer of the initiator of the collaboration session. Steps 721-723 represent those steps that are carried out at the collaboration server 130. Steps 731-732 represent those steps that are carried out at the client computer of the participant or invitee of the collaboration session.

In step 711, the initiator selects an object (e.g., an image) for collaboration. Then, in step 712, the initiator identifies the participants for the collaboration session. This can be done by checking off the boxes shown in FIG. 3A or typing in the e-mail addresses into the dialog that opens up in response to a selection of the “Collaborate . . . .” item from any of the contextual menus shown in FIGS. 3B-3D. In step 713, the object and the participant list is transmitted to the collaboration server 130. Subsequently, in step 714, the initiator may launch the collaboration session.

The collaboration server 130 stores the object received from the client computer of the initiator and prepares an e-mail or Instant Message for the participants (step 721). In step 722, this message is transmitted. Independent of this e-mail or IM management function, the collaboration server 130 also hosts the collaboration session when it is launched by either the initiator or the participants (step 723).

In step 731, the e-mail or Instant Message transmitted by the collaboration server 130 in step 722 is received at a client computer of a recipient and displayed. When the participant clicks on the hyperlink included in the message for launching the collaboration session, the collaboration session is launched (step 732).

When a collaboration is asynchronous, participants may not be aware that the object of the collaboration is being annotated. In order to keep the participants up to date on new comments and new annotations, the collaboration server 130 is configured with a notification mechanism to inform participants that new comments or new annotations took place while they were offline.

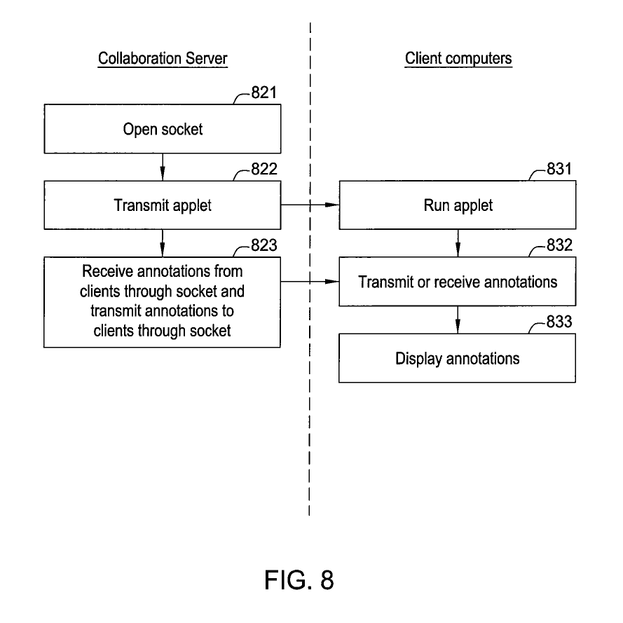

FIG. 8 is a flow diagram that illustrates the steps to manage a collaboration session after it has been launched. In step 821, the collaboration server 130 opens a socket for communicating with client computers bi-directionally, and this socket remains open throughout the collaboration session. In step 822, the collaboration server 130 transmits a Flash applet, or alternatively a Java applet, to client computers of those participants of the collaboration sessions who have launched the collaboration session.

The client computers receive the applet from the collaboration server 130 and run the applet (step 831). A bi-directional connection is thereby established between the collaboration server 130 and the client computers through the socket that was opened in step 821, Thereafter, any annotations made through the client computers are transmitted to the collaboration server 130 (step 832). The client computers also receive annotations made by other client computers through the collaboration server 130 (step 832). In step 833, the annotations are displayed.

In step 823, the collaboration server 130 receives annotations from various client computers and passes on these annotations to other client computers. As a result, all annotations, regardless of the source, can be displayed on all of the client computers simultaneously and in real-time. The annotations are communicated between the collaboration server 130 and the client computers as XML files. However, any type of data exchange protocol may be employed so long as the communication program running on the collaboration server 130 and the applets running on the client computers are changed accordingly.

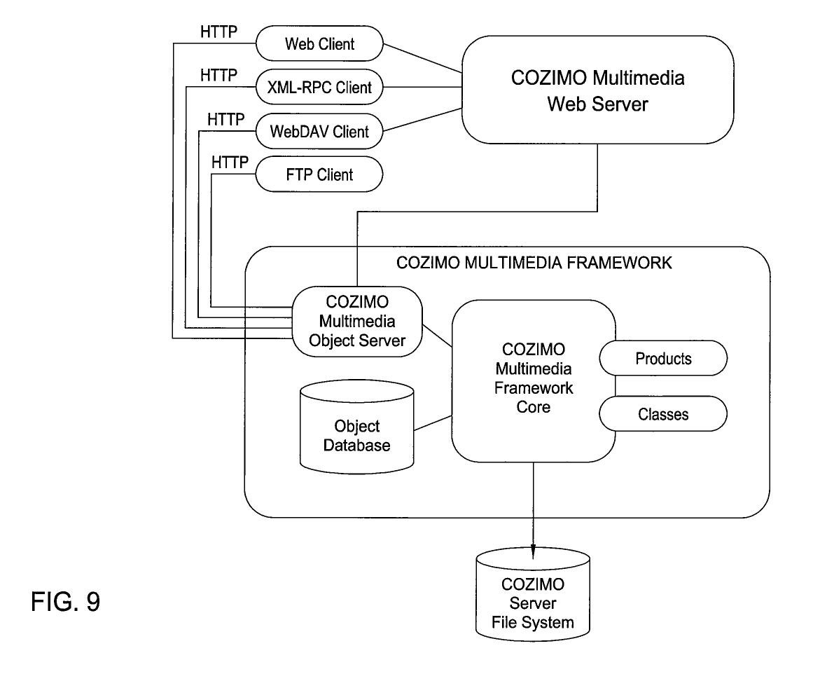

FIG. 9 is a schematic diagram of an embodiment of a collaboration server 130 that is provided by Cozimo Technologies, Inc. for hosting a collaboration session. The Cozimo Multimedia Framework forms the foundation of the collaboration server 130. The Cozimo Multimedia Framework employs the ZOPE open source framework as a base.

The Cozimo Multimedia Framework Core is the central framework module. It provides an object-model back-end to describe objects, transactions, basic security levels, basic membership hooks, dynamic information sharing as well as a basic search engine for dynamic queries and lookups. An important property of the Core is that it is pluggable. Dynamic Products and Classes are defined to implement different collaboration and data sharing models on top of the framework's core. This is important because different types of media content generally require different interaction and collaboration models. The flexibility of the core enables fast design-to-prototype-to-release cycles, as the responsibilities and collaboration models are well defined through the Products and Classes programming interfaces.

The Cozimo Multimedia Framework Core stores most of the content and the metadata in an Object Database. An Object Database enables fast content retrieval of complex data structures. The Cozimo Multimedia Framework has a modular, object-oriented architecture to enable it to readily manage the type of complex data relationships that are inherent in distributed collaborative environments. The object database management system for the Cozimo Multimedia Framework has a storage model that is both high performance and compatible with the object model.

The Cozimo Collaboration Application handles large amounts of data, consisting, for example, of large images, videos, audio, text documents, and non-linear flash-animated content. The Cozimo Multimedia Framework accommodates the size and complexity of these different content types by interfacing with the File System Server, while synchronizing with metadata stored in the Object Database. This ensures that the system optimizes resource usage (memory consumption and storage).

Storing Metadata in the Object Database facilitates fast lookups and information queries by not incurring the performance cost of retrieving large chunks of content data. For example, image thumbnails are stored as Metadata in the Database, so that the content listings on the web clients can be rendered without the need to retrieve all the data for the image itself.

Metadata are stored in the Database as Dublin Core Metadata to facilitate the finding, sharing and management of information related to the content and collaboration model. This also ensures easy interconnection with external systems in the future and enables the quick and efficient implementation of project archiving and restoration.

The Multimedia Object Server provides the Internet connectivity, supporting many network protocols including HTTP, FTP, XML-RPC, Fast-CGI and PCGI. The Multimedia Object Server synchronizes media-rich content with the Cozimo Multimedia Core to support real-time collaboration sessions. The Multimedia Object Server also interfaces directly to web clients for data exchanges that do not require real-time collaboration, or for client requests of metadata.

In the embodiment of the collaboration server illustrated in FIG. 9, the separation between the Multimedia Web Server and the Object Server is provided for several reasons. First, it is provided to balance the asynchronous requests going from the web client to the framework through the Multimedia Server. Second, the separation means that collaboration tools can be developed and supported independently.

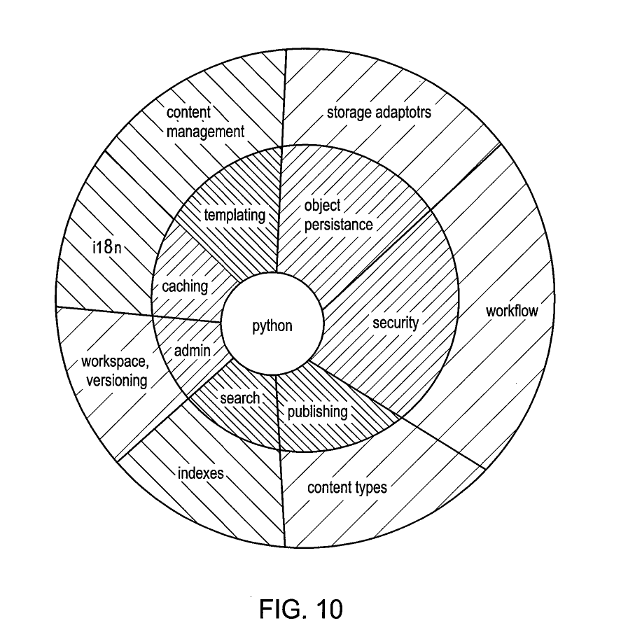

FIG. 10 is a high-level physical representation of the software stack of the collaboration server 130 that is provided by Cozimo Technologies, Inc. for hosting a collaboration session. In the center of the diagram, the Python programming language includes low-level modules such as PIL (the Python Imaging Library) and NumPy (Numeric Python). The next layer consists of a series of logical components (shown in blue) that include security, object persistence, publishing, search, admin, caching and templating. The logical components are further described below:
Templating. This module implements a Templating Language, called ZTP. ZTP allows for dynamic generation of HTML code and supports the writing of snippets of restricted Python code directly on the HTML template to represent content logic.
Search. Most pages in the Cozimo web application are dynamic. The templating mechanism is used to render dynamic pages based on queries to the Server.
Publishing. This module implements the foundation for the Cozimo Multimedia Object Server and the Cozimo Multimedia Web Server. It is also used to implement the Cozimo Multimedia Framework Core. It defines the rules for publishing content in the Cozimo Collaboration Framework. The Publishing module is the foundation of the application's content types specification.
Caching. This module supports multimedia content and is configured to work with the components of the Cozimo Multimedia Framework and to take into account time paths—temporal clues inherent to the non-linearity of some content types (such as interactive flash content, or some video formats)—as the same content can possibly have different states or representations according the temporal path, creating a constantly changing visual representation that the annotation content has to follow.
Admin. This module collaborates with the Security module and provides team workspace tools and administrative controls that manage content from remote clients.
Security. The Security module manages all the security, rights, permissions and user related aspects of the application, and allows a project owner to remotely control what the other project collaborators can see. The Cozimo Object Server is in charge of physically distributing security information to the Cozimo Web Servers involved in the collaboration session.
Object Persistence. This module translates requests from the Cozimo Multimedia Web Server into requests to the Object Database and File System. It can handle requests that are dynamically translated into a combination of requests that enable the fast storage and retrieval of heavy, rich-media content as asynchronous data transfers by decoupling and staging the requests at a low-level to permit the application of arbitrary storage and compression mechanisms in a dynamic way. For example, depending on system load levels, the system chooses whether to apply compression algorithms or whether to defer the compression asynchronously while committing right away the metadata to the object database. This means that users never have to save their work, as every interaction, every brush stroke, every comment posted is immediately and safely stored in the object database.
Indexing. This module works with the caching mechanism and enables the Object Server, for example, to answer complex object queries very efficiently.

The indexing module also performs the more traditional task of returning proxies instead of object instances for immediate queries. Indexing enhances the user experience by removing the delays caused by page reloads and by supporting advanced user interface search paradigms such as real-time search results. The Indexing module provides for fast, robust, flexible, external, transactional content lookup in the context of the caching mechanism.
Content Types. This module defines and publishes the different content types (i.e. images, video, documents) that are supported by the collaborative framework. This module defines how the system understands the types of information within it—who uses what information and in what context. It also defines how this information can be shared and reused in different scenarios or workflows. This module unifies the content, regardless of who is annotating it, reviewing it or versioning it. Basing the Content Types modules on Document Type Definitions (DTD) allows new content types at the low-level to be quickly defined and supported, thereby opening the possibility for innovation at the tool level. The DTD allows the information element model to be defined, while the Products and Classes interfaces allow the block that represents such a model in the Cozimo Collaboration Framework to be built.
Workflow. This module is built on top the security model and defines how people and tasks interact to create, update, manage and deliver content. In a classical workflow approach to content management, workflow ensures an order in the evolution of the content. The workflow module implements a workflow service that abstracts access to workflow engines that manage static workflow specifications, processes that defines tasks, transitions that define possible ways to evolve in the workflow, and the workflow tool itself, offering views and controllers in the model-view-controller paradigm. The innovation of the workflow model is in the way it is distributed across the clients involved in a collaboration session, e.g., through on an interaction between the Cozimo Object Server and the Cozimo Web Server or through a single, multi-threaded instance of the Cozimo Web Server.
Storage Adaptor. This module defines an interface to connect to object databases in an asynchronous and atomic/transactional fashion.
Content Management. This module integrates the templating facilities of Cozimo, and is used mostly to implement the front-end of the Cozimo Object Server by collaborating with the publishing module to assemble and produce the pages that are rendered by the Web Client/Agent. The Cozimo Web Server, and not the Object Server, is the component that is responsible for pushing the collaboration tools to the Web Client according to the content being collaborated on. The Content Management module prepares the content representation to host the collaboration tools, allowing the Object and Web server to work in tandem.
Internationalization (i18n). This module abstracts the representation of text content allowing for internationalization of the content itself as well as user interface components. To accomplish this, it collaborates with the Content Management module while sitting on top of the caching mechanism.

The Workspace and Versioning modules are important in defining the user experience. They rely heavily on the Admin module, as they implement roles and permissions. The Workspace, including the high-level representation of the user interface components, is tightly coupled to the security model because project administrators can, for example, control remote workspaces. The look-and-feel of the application workspace dynamically depends on many factors, including the user driving the collaboration, the owner of the current project being collaborated on, the roles of the users participating in a collaborative session, etc. The Workspace module manages all of this functionality so that the look and feel of the application workspace are customized and extended to remote workspaces, in a place-less fashion.

While particular embodiments according to the invention have been illustrated and described above, those skilled in the art understand that the invention can take a variety of forms and embodiments within the scope of the appended claims.

What is claimed is:

1. A method of initiating a collaboration session, wherein the collaboration session is to be hosted on a first server computer, comprising the steps of:
displaying a web page hosted on a second server computer;
receiving inputs that specifies an object displayed on the web page as the subject of the collaboration session and e-mail addresses of users who are to participate in the collaboration session; and
causing an e-mail communication that includes a hyperlink for launching the collaboration session for said object to be prepared and transmitted to each of said e-mail addresses.

2. The method according to claim 1, wherein the e-mail communication is prepared and transmitted by a client computer that performs the steps of displaying, receiving and causing.

3. The method according to claim 1, wherein the step of causing includes the step of transmitting the object and the e-mail addresses to the first server computer and the e-mail communication is prepared and transmitted by the first server computer.

4. The method according to claim 1, wherein the step of displaying is carried out through a browser that is configured to display a contextual menu, and the contextual menu includes a selectable item for initiating the collaboration session.

5. The method according to claim 4, wherein the context menu is displayed in response to an actuation of an input device while a cursor associated with said input device is positioned over said object.

6. The method according to claim 5, wherein said object is an image.

7. The method according to claim 1, wherein the e-mail communication comprises a calendar entry that includes said hyperlink and specifies a time and a date for the collaboration session.

8. A method of initiating a collaboration session, wherein the collaboration session is to be hosted on a server computer, comprising the steps of:
displaying an object on a client computer that is connected to the server computer over the Internet;
detecting an actuation of an input device while a cursor associated with said input device is positioned over said object;
in response to said detecting, displaying a contextual menu that includes a selectable item for initiating the collaboration session; and
if said item for initiating the collaboration session is selected, causing an e-mail communication that includes a hyperlink for launching the collaboration session to be prepared and transmitted.

9. The method according to claim 8, wherein the e-mail communication is prepared and transmitted by said client computer.

10. The method according to claim 8, wherein the step of causing includes the step of transmitting the object to the server computer and the e-mail communication is prepared and transmitted by the server computer.

11. The method according to claim 8, wherein the e-mail communication comprises a calendar entry that includes said hyperlink and specifies a time and a date for the collaboration session.

12. The method according to claim 8, wherein the object comprises a file name or an icon corresponding to an image that is the subject of the collaboration session.

13. The method according to claim 12, wherein the object is displayed through a file browser.

14. The method according to claim 8, wherein the object comprises an image that is the subject of the collaboration session.

15. The method according to claim 14, wherein the image is displayed through an e-mail interface.

16. A method of managing a request for a collaboration session by a server computer that is to host the collaboration session, comprising the steps of:
receiving e-mail addresses of users who are to participate in the collaboration session;
receiving an object that is the subject of the collaboration session;
preparing an e-mail communication that includes a hyperlink for launching the collaboration session for said object; and
transmitting the e-mail communication to each of said e-mail addresses.

17. The method according to claim 16, wherein the e-mail addresses and the object are received in response to inputs from a user who is logged into server computer.

18. The method according to claim 16, wherein the e-mail addresses and the object are received in response to inputs from a user who is not logged into server computer.

19. The method according to claim 16, wherein the e-mail communication comprises a calendar entry that includes said hyperlink and specifies a time and a date for the collaboration session.

20. The method according to claim 16, further comprising the steps of:
preparing another e-mail communication that includes a record of comments and annotations made to the object during the collaboration session; and
transmitting said another e-mail communication to one of said e-mail addresses.
